(19) United States
(12) Patent Application Publication
(10) Pub. No.: US 2017/0341923 A1
(43) Pub. Date: Nov. 30, 2017

(54) Moveable Saddle Rack

(71) Applicant: DeWitt Innovations, LLC, Bryan, TX (US)

(72) Inventor: Lee John DeWitt, Bryan, TX (US)

(21) Appl. No.: 15/606,371

(22) Filed: May 26, 2017

Related U.S. Application Data
(60) Provisional application No. 62/342,550, filed on May 27, 2016.
(60) Provisional application No. 62/418,377, filed on Nov. 7, 2016.

(51) Int. Cl. B68C 1/00; B60P 3/04; A47B 81/00

(52) U.S. Cl. CPC B68C 1/002; A47B 81/00; B60P 3/04

(57) ABSTRACT

A moveable saddle rack that may be laterally translatable across a trailer, vertically translatable to facilitate user access to an upper saddle seat of the saddle rack, or both laterally translatable and vertically translatable.

### CROSS-REFERENCE TO RELATED APPLICATIONS

This application claims the benefit of U.S. Provisional Patent Application Ser. No. 62/342,550 filed May 27, 2016 and entitled “Moveable Saddle Rack”, and U.S. Provisional Patent Application Ser. No. 62/418,377 filed Nov. 7, 2016 and entitled “Moveable Saddle Rack”, both of which are incorporated herein by reference in their entirety for all purposes.

### TECHNICAL FIELD

The present disclosure relates to apparatus and methods for storing and retrieving saddles, and more particularly, the present disclosure relates to moveable saddle racks that may be laterally translatable from one location to another, such as across a trailer or across a tack room in a stable, and/or vertically translatable to allow easier user access to an upper portion of the saddle rack.

### BACKGROUND

Stationary saddle racks may be located in buildings, such as tack rooms in stables, or in the tack compartments of different types of trailers used to haul horses. These saddle racks may be designed to store a plurality of saddles in a stacked vertical arrangement.

Standard horse trailers typically include a designated tack compartment located in the back of the trailer with a stationary saddle rack that may be accessed from the ground.

Stock combo trailers are popular alternatives to standard horse trailers because they are less expensive, lighter weight, smaller and more versatile, making them easier to haul. However, stock combo trailers typically include a tack compartment located in the front of the trailer with a stationary saddle rack positioned on a far wall opposite to the entry door of the tack compartment. This location of the saddle rack requires a user to step up into the trailer and down from the trailer while carrying a heavy saddle as the user loads and unloads saddles on the saddle rack.

### SUMMARY

The present disclosure relates to apparatus and methods for storing and retrieving saddles. The apparatus may comprise a moveable saddle rack designed to store a plurality of saddles in a stacked vertical arrangement.

In some implementations, the moveable saddle rack may be laterally translatable from one location to another. The moveable saddle rack may translate along a track coupled to an interior surface of a building or a trailer.

In operation, the moveable saddle rack may be laterally translated to a location proximate to a door of the tack room or trailer to facilitate user access to the saddle rack, and to avoid stepping into the trailer.

In some implementations, the moveable saddle rack may be vertically translatable from one height to another. The moveable saddle rack may include a moveable frame portion that is vertically translatable with respect to a stationary frame portion. An actuator may aid the vertical translation of the moveable frame portion. In various implementations, the moveable saddle rack may comprise a mechanical actuator, an electrical actuator, a hydraulic actuator, a pneumatic actuator, or a combination actuator. The moveable saddle rack may have a mechanical actuator comprising a gas spring. The moveable saddle rack may have an electrical actuator comprising an electric winch. The moveable saddle rack may have a combination mechanical actuator and electrical actuator comprising a gas spring in combination with an electric motor driven piston actuator.

In operation, the moveable frame portion may be vertically translated downwardly from a storage height to a load height that facilitates user access to an upper portion of the saddle rack. The moveable frame portion may also be vertically translated upwardly from the load height to the storage height.

In some implementations, the moveable saddle rack may be both laterally translatable from one position to another and vertically translatable from one height to another.

In an implementation, a moveable saddle rack includes a frame supporting a plurality of saddle seats spaced apart in a stacked vertical arrangement, and the moveable saddle rack is laterally translatable from a first location to a second location. The apparatus may further include a translation assembly coupled to the frame, and the translation assembly may be adapted to travel along a track disposed on an interior surface of a building or a trailer. The apparatus may further include a latch receiver on one of the translation assembly and the track, and a latch on the other of the translation assembly and the track. The latch may be adapted to engage the latch receiver to maintain the moveable saddle rack in the first location or the second location. A release mechanism may be operable to withdraw the latch from the latch receiver to facilitate lateral translation of the moveable saddle rack. In various implementations, the spacing of the plurality of saddle seats on the frame is adjustable and/or the position of at least one of the latch receiver and the latch is adjustable.

In some implementations, moveable portion of the frame is vertically translatable from a first height to a second height with respect to a stationary portion of the frame. The apparatus may further include an actuator that facilitates vertical translation of the moveable frame portion. In various implementations, the actuator may include a mechanical gas spring, an electric winch, an electric piston actuator, and/or some combination thereof. The distance between the first height and the second height may be adjustable and/or the height of the stationary frame portion may be adjustable.

In an implementation, a method of accessing a saddle rack includes laterally translating a saddle rack from a travel position proximate to a wall of a trailer to an access position proximate to an entry door of the trailer, and loading or unloading a saddle from the saddle rack without stepping into the trailer. The method may further include laterally translating the saddle rack back to the travel position after loading or unloading the saddle. The method may further include vertically translating at least one portion of the saddle rack downwardly from a storage height to a load height before loading or unloading the saddle from the saddle rack. The method may further include vertically translating the at least one portion of the saddle rack back to the storage height after loading or unloading the saddle. In various implementations, the vertical translating may be achieved mechanically, electrically, or electrically and mechanically.

The details of one or more implementations are set forth in the accompanying drawings and the description below. Other features, objects, and advantages of the implementations will be apparent from the description and drawings.

### BRIEF DESCRIPTION OF THE DRAWINGS

For a more complete understanding of this disclosure and its features, reference is now made to the following description, taken in conjunction with the accompanying drawings, in which:

FIG. 1 illustrates a side perspective view of an implementation of a laterally translatable saddle rack coupled to a track and positioned proximate to a far trailer wall opposite to the entry door of a tack compartment, according to the present disclosure.

FIG. 2 illustrates a side perspective view of the laterally translatable saddle rack of FIG. 1 after being translated to a position proximate to the entry door of the tack compartment, according to the present disclosure.

FIG. 3 illustrates a front side perspective view of an implementation of a vertically translatable saddle rack having a gas spring actuator, according to the present disclosure.

FIG. 4 illustrates a back side perspective view of the vertically translatable saddle rack of FIG. 3, according to the present disclosure.

FIG. 5 illustrates a back plan view of a portion of the vertically translatable saddle rack of FIG. 3, according to the present disclosure.

FIG. 6 illustrates an enlarged back view of an upper roller system of the vertically translatable saddle rack of FIG. 3, according to the present disclosure.

FIG. 7 illustrates a front plan view of an implementation of the vertically translatable saddle rack of FIG. 3 with the stationary frame portion coupled to a fixture within the tack compartment of a trailer, according to the present disclosure.

FIG. 8 illustrates a front side perspective view of another implementation of a vertically translatable saddle rack having an electric winch actuator, according to the present disclosure.

FIG. 9 illustrates a front side perspective view of the vertically translatable saddle rack of FIG. 8 after being lowered by the electric winch actuator to a load position, according to the present disclosure.

FIG. 10 illustrates a front side perspective view of an implementation of a vertically translatable saddle rack having a gas spring and electric actuator, according to the present disclosure.

FIG. 11 illustrates a back side perspective view of the vertically translatable saddle rack of FIG. 10, according to the present disclosure.

FIG. 12 illustrates a back plan view of a portion of the vertically translatable saddle rack of FIG. 10, according to the present disclosure.

FIG. 13 illustrates a side perspective view of an implementation of an adjustable rear latch receiver for engaging a rear latch to retain a laterally translatable saddle rack in a travel position, according to the present disclosure.

FIG. 14 illustrates a side perspective view of an implementation of an adjustable front latch for engaging a front latch receiver to retain a laterally translatable saddle rack in an access position, according to the present disclosure.

FIG. 15 illustrates a front plan view of an implementation of a vertically translatable saddle rack having a stationary frame portion that includes an extended slotted channel for adjustable height setting, according to the present disclosure.

### DETAILED DESCRIPTION

When storing and retrieving saddles from conventional stationary saddle racks installed in stock combo trailers, users must step up and down approximately 18 inches into and out of the trailer when loading and unloading saddles. It is difficult for users to make that step carrying a saddle weighing about 50 pounds while maneuvering through a doorway that is just wide enough to fit the saddle through it. Users also risk physical injury by doing so. The difficulty and the possibility for injury only increase as users load and unload multiple saddles, which also tends to be time consuming and tiring.

Embodiments of the present disclosure generally provide improved apparatus and methods for storing and retrieving saddles. The apparatus may comprise a moveable saddle rack designed to store a plurality of saddles in a stacked vertical arrangement. The moveable saddle rack may be laterally translatable from one position to another and/or the moveable saddle rack may be vertically translatable from one height to another.

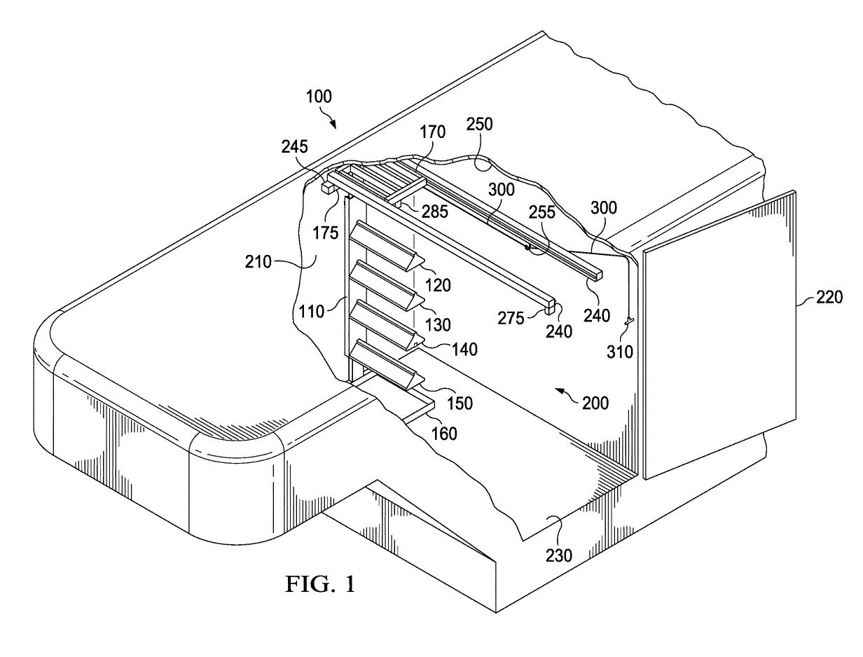

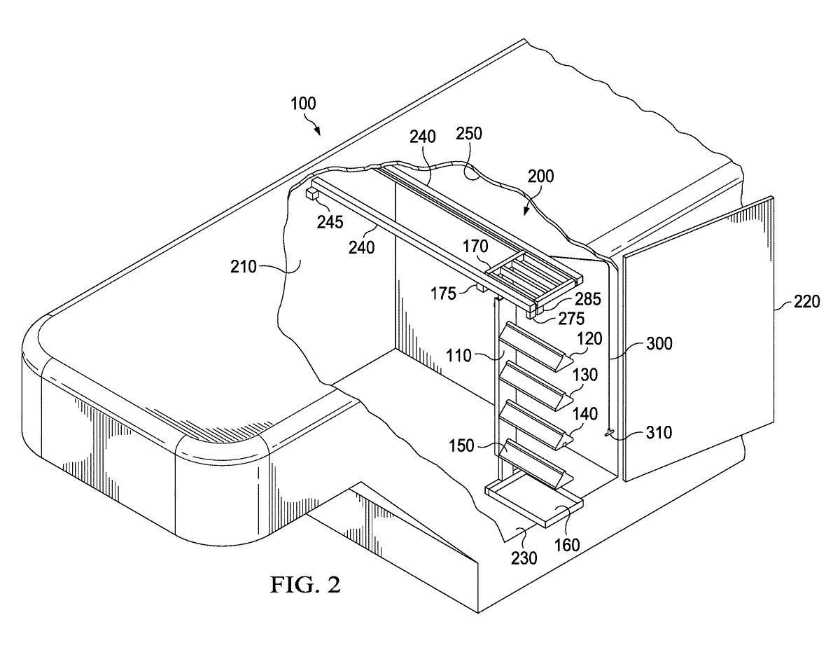

FIGS. 1 and 2 depict side perspective views of a moveable saddle rack 100 that is laterally translatable within a tack compartment 200 of a trailer. FIG. 1 depicts the moveable saddle rack 100 in a first position proximate to a far wall 210 of the tack compartment 200, and FIG. 2 depicts the moveable saddle rack 100 in a second position proximate to an entry door 220 of the tack compartment 200. The first position may be referred to as the travel position and the second position may be referred to as the access position.

The moveable saddle rack 100 may be designed to store one saddle or a plurality of saddles in a stacked vertical arrangement, such that each saddle is stored on an individual tier or seat 120, 130, 140, 150 coupled to a frame 110 of the saddle rack 100. Other arrangements and numbers of saddle seats are also contemplated according to the present disclosure.

The individual saddle tiers or seats 120, 130, 140, 150 may be fixedly coupled to the frame 110 such that each seat 120, 130, 140, 150 maintains a fixed lateral and vertical position on the frame 110, as well as a fixed vertical spacing between seats 120, 130, 140, 150. In another implementation, one or more of the individual saddle tiers or seats 120, 130, 140, 150 may be adjustably coupled to the frame 110 to allow variations in the lateral and/or vertical positions of each adjustable seat 120, 130, 140, 150 on the frame 110, and/or to allow variations in the vertical spacing between seats 120, 130, 140, 150.

The moveable saddle rack 100 may further include a stirrup shelf 160 coupled to a lower portion of the frame 110. The stirrup shelf 160 retains stirrups from the saddle stored on the lowermost seat 150 to prevent those stirrups from dragging along the floor 230 of the tack compartment 200 as the moveable saddle rack 100 laterally translates across the trailer.

The stirrup shelf 160 may be fixedly coupled to the frame 110 such that the stirrup shelf 160 maintains a fixed lateral and vertical position on the frame 110, and a fixed vertical spacing off the floor 230 of the tack compartment 200. In another implementation, the stirrup shelf 160 may be adjustably coupled to the frame 110 to allow variations in the lateral and/or vertical position of the stirrup shelf 160 with respect to the frame 110 and/or to allow variations in the vertical spacing between the lowermost seat 150 and the stirrup shelf 160, as well as the stirrup shelf 160 and the floor 230 of the tack compartment 200. Such an adjustable stirrup shelf 160 would enable adjustability of the overall vertical span of the moveable saddle rack 100 to facilitate use of the moveable saddle rack 100 in tack compartments 200 of varying heights.

As best shown in FIG. 1, the moveable saddle rack 100 may further comprise a translation assembly 170 operably coupled to a track 240 disposed along an interior surface of the tack compartment 200. In various implementations, the translation assembly 170 may comprise wheels, rollers, bearings, sliders, or other mechanisms operable to roll or slide with respect to the track 240. In the implementation depicted in FIG. 1, the track 240 is disposed to run along and substantially parallel to the ceiling 250 of the tack compartment 200, but other configurations are possible. For example, the track 240 may be disposed to run along and at an angle to the ceiling 250 of the tack compartment 200 such that the track 240 is positioned adjacent to the ceiling 250 proximate to the far wall 210 of the tack compartment 200 and offset from the ceiling 250 proximate to the entry door 220 of the tack compartment 200. In this configuration, the angle of the track 240 causes the moveable saddle rack 100 to lower vertically as it is translated along the track 240 from the travel position to the access position.

The moveable saddle rack 100 may further include a rear latch 175 on the translation assembly 170 that couples with a rear latch receiver 245 on the track 240 to retain the moveable saddle rack 100 in the travel position shown in FIG. 1. In various implementations, the rear latch 175 may comprise a mechanical or magnetic component that couples with a corresponding mechanical or magnetic component of the rear latch receiver 245.

In an implementation, the rear latch receiver 245 may be fixedly coupled to the track 240. In another implementation, the rear latch receiver 245 may be adjustably coupled to the track 240 to facilitate installation of the rear latch receiver 245 and to allow variations in the position of the rear latch receiver 245 on the track 240, as needed, to properly engage the rear latch 175.

A line 300 may extend between the rear latch 175 on one end and a handle 310 positioned at the entry door 220 on the other end. Between the rear latch 175 and the entry door 220, the line 300 may be routed through a hook 255 or other coupling point on the ceiling 250 or other interior surface of the tack compartment 200. In various implementations, the line 300 may comprise rope, chain, wire or other similar structure.

In operation, when a user is ready to access the moveable saddle rack 100 for storing or retrieving saddles, the user stands on the ground near the entry door 220 of the tack compartment 200 and pulls on the line 300 via handle 310. When the user pulls the handle 310, a force is exerted on the line 300 and thereby on the rear latch 175. With sufficient force, the rear latch 175 is withdrawn from the rear latch receiver 245 to release the moveable saddle rack 100 from the travel position shown in FIG. 1.

As the user continues to pull on the line 300 via the handle 310, the translation assembly 170 laterally translates the moveable saddle rack 100 along the track 240 and across the tack compartment 200 of the trailer. In this manner, the moveable saddle rack 100 is laterally translated to the access position shown in FIG. 2, where the moveable saddle rack 100 is proximate to the entry door 220 of the tack compartment 200. In an embodiment, the track 240 may include a front latch 275 near the end of the track 240 adjacent to the entry door 220 designed to engage a front latch receiver 285 positioned on the front end of the translation assembly 170 to thereby maintain the moveable saddle rack 100 in the access position shown in FIG. 2.

In an implementation, the front latch 275 may be fixedly coupled to the track 240. In another implementation, the front latch 275 may be adjustably coupled to the track 240 to facilitate installation of the front latch 275 and to allow variations in the position of the front latch on the track 240, as needed, to properly engage the front latch receiver 285.

As shown in FIG. 2, the moveable saddle rack 100 is positioned near the entry door 220 so that a user can load and unload saddles onto the saddle seats 120, 130, 140 and/or 150 without stepping up and down from the tack compartment 200 of the trailer. Once the user has finished loading or unloading saddles from the moveable saddle rack 100 in the access position shown in FIG. 2, the user may disengage the front latch 275 from the front latch receiver 285 near the front end of the track 240 adjacent to the entry door 220 and thereby release the moveable saddle rack 100 from the access position shown in FIG. 2.

Then the user may push the moveable saddle rack 100 back into the tack compartment 200 with sufficient force that the translation assembly 170 laterally translates the moveable saddle rack 100 along the track 240 and across the tack compartment 200 of the trailer. In this manner, the moveable saddle rack 100 is laterally translated back to the storage position shown in FIG. 1, where the rear latch 175 engages the rear latch receiver 245 to retain the moveable saddle rack 100 in the travel position.

In an implementation, the moveable saddle rack 100 requires no additional space in the tack compartment 200 as compared to conventional stationary saddle racks. Therefore, users are not required to purchase a longer trailer to accommodate the moveable saddle rack 100. The laterally translatable moveable saddle rack 100 may be installed in buildings, such as tack rooms of horse barns or stables, as well as in horse trailers. In an implementation, the moveable saddle rack 100 is located in substantially the same position as a conventional stationary saddle rack when the moveable saddle rack 100 is installed within a stock combo trailer and located in the travel position shown in FIG. 1. In various implementations, the moveable saddle rack 100 may be factory installed in a trailer, or the moveable saddle rack 100 may be retrofit into an existing trailer originally equipped with a conventional stationary saddle rack.

In an implementation, the moveable saddle rack 100 is laterally translatable along a linear path or along a curved path, but the moveable storage rack 100 is not rotationally translatable.

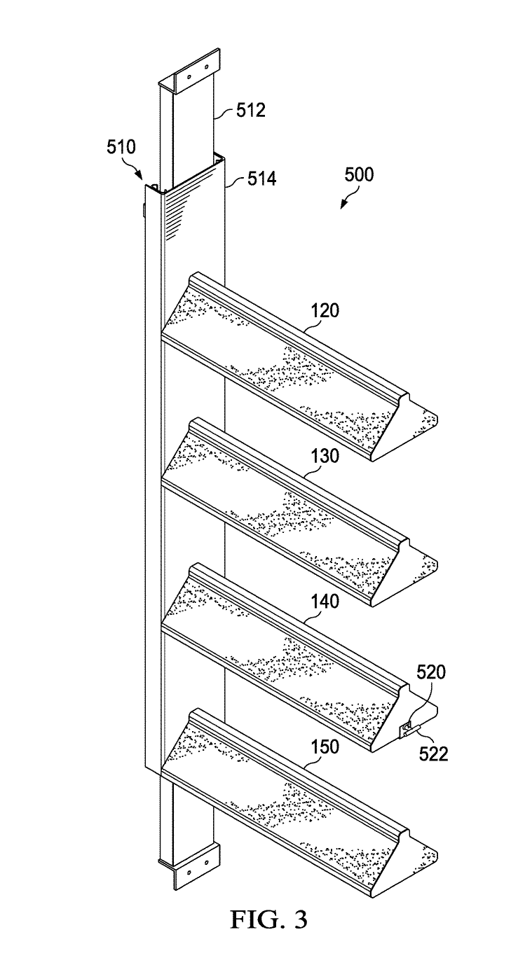

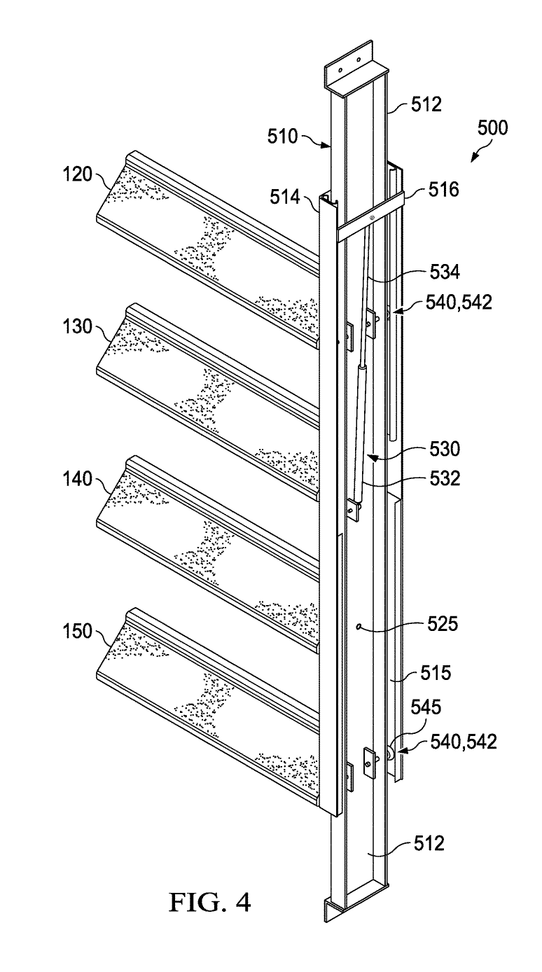

Referring now to FIGS. 3 and 4, which depict a front side perspective view and a back side perspective view, respectively, of a mechanically-actuated moveable saddle rack 500 that is vertically translatable from one height to another.

Like the moveable saddle rack 100 of FIGS. 1 and 2, the moveable saddle rack 500 of FIGS. 3 and 4 may be designed to store one saddle or a plurality of saddles in a stacked vertical arrangement, such that each saddle is stored on an individual tier or seat 120, 130, 140, 150 coupled to a frame 510 of the saddle rack 500. Other arrangements and numbers of saddle seats are also contemplated according to the present disclosure.

The frame 510 of the moveable saddle rack 500 may include a stationary frame portion 512 and a moveable frame portion 514 that is operable to vertically translate from one height to another with respect to the stationary frame portion 512. The saddle seats 120, 130, 140, 150 may be coupled to the moveable frame portion 514 such that the height of the saddle seats 120, 130, 140, 150 is adjusted as the moveable frame portion 514 vertically translates.

In an implementation, the two portions 512, 514 of the frame 510 are coupled together at a first height by a retainer 520. The first height may be referred to as the storage height. The retainer 520 may be positioned in any convenient location where it can extend through the moveable frame portion 514 and into an aperture 525 in the stationary frame portion 512. As best shown in FIG. 3, the retainer 520 may be positioned to also extend through any one of the saddle seats, such as saddle seat 140, on the moveable saddle rack 500. The retainer 520 may further include a handle 522 extending beyond the saddle seat 140. In an implementation, the retainer 520 comprises a spring-loaded pin that may be extended or retracted by rotating the handle 522, but other configurations are contemplated by the present disclosure.

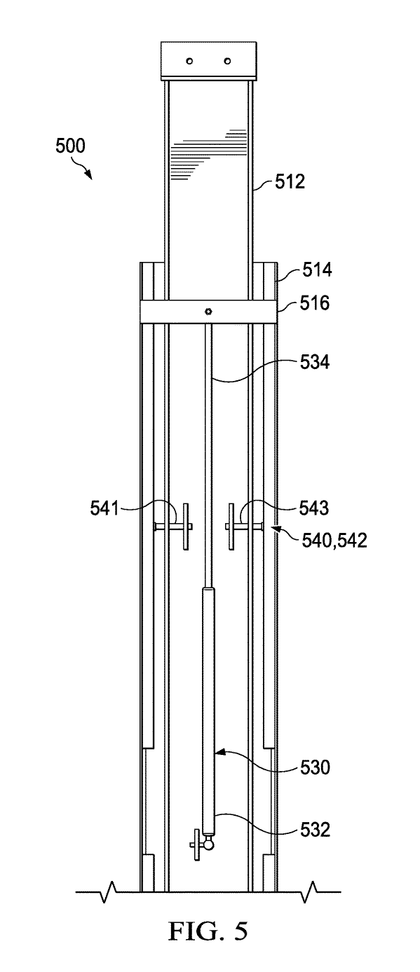

Referring now to FIG. 4 and FIG. 5, which depicts a partial back plan view, the moveable saddle rack 500 may further comprise an actuator operable to aid the vertical translation of the moveable frame portion 514 from one height to another. In an implementation, the actuator is a mechanical actuator, such as a gas cylinder 530, also referred to as a gas spring, having a piston chamber 532 and a piston rod 534 that engages a bar 516 coupled to and forming part of the moveable frame portion 514. Other types of actuators are contemplated by the present disclosure.

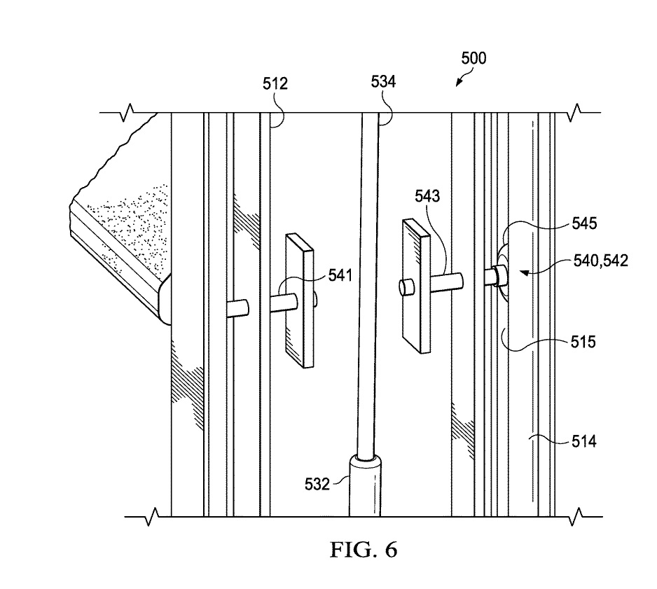

Referring now to FIG. 4, FIG. 5 and FIG. 6, which depicts a partial back perspective view, the moveable saddle rack 500 may further comprise a vertical translation system 540. In various implementations, the vertical translation system 540 may comprise wheels, rollers, bearings, sliders, or other mechanisms that facilitate vertical translation of the moveable frame portion 514 with respect to the stationary frame portion 512. In an implementation, the vertical translation system 540 may comprise an upper roller system 542 and a lower roller system 544. The roller systems 542, 544 may each comprise a plurality of bars 541, 543 coupled to the stationary frame portion 512 and each supporting a roller 545 disposed within a track 515 of the moveable frame portion 514. In other implementations, the roller systems 542, 544 may each comprise a single bar extending between two rollers 545 disposed within tracks 515 on either side of the moveable frame portion 514. The rollers 545 are operable to vertically translate along tracks 515 as the moveable frame portion 514 is moved downwardly or upwardly with respect to the stationary frame portion 512.

In operation, a user will first determine whether or not to operate the moveable saddle rack 500. In some circumstances, such as when loading and unloading saddles from the lower saddle seats 140, 150, there may be no need to vertically translate the moveable saddle rack 500. If a user decides to operate the moveable saddle rack 500 to access one or more of the upper saddle seat(s) 120, 130 for storing or retrieving saddles, the user retracts the retainer 520 via the handle 522 and pulls against the spring force to withdraw the retainer 520 from the aperture 525 in the stationary frame portion 512. Once the retainer 520 is withdrawn from the aperture 525, the moveable saddle rack 500 is released from the storage position shown in FIGS. 3 and 4.

Then the user may pull downwardly on the moveable frame portion 514 via any one of the lower saddle seat(s) 130, 140, 150 until the vertical translation system 540 vertically translates the moveable frame portion 514 downwardly via rollers 545 moving along the tracks 515. The actuator, such as the gas spring 530, aids in the vertical translation so the user is not required to exert much force. In this manner, the moveable saddle rack 500 is vertically translated downwardly to a load height that facilitates user access to the upper saddle seats 120, 130. In an implementation, the moveable frame portion 514 vertically translates approximately 10-inches with respect to the stationary frame portion 512, but other distances are contemplated by the present disclosure.

Once the user has finished loading or unloading saddles from the moveable saddle rack 500 in the load position, the user may pull upwardly on the moveable frame portion 514 via any one of the saddle seat(s) 120, 130, 140, 150 until the vertical translation system 540 vertically translates the moveable frame portion 514 upwardly via rollers 545 moving along the tracks 515. The actuator, such as the gas spring 530, aids in the vertical translation so the user is not required to exert much force. In this manner, the moveable saddle rack 500 is vertically translated upwardly to the storage height shown in FIGS. 3 and 4, where the retainer 520 engages the aperture 525 in the stationary frame portion 512 to retain the moveable saddle rack 500 at the storage height.

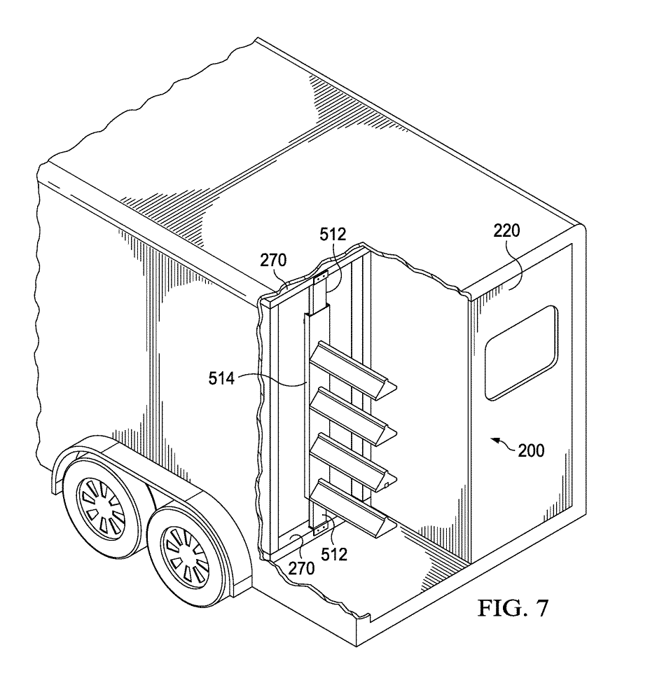

In an implementation, the vertically translatable moveable saddle rack 500 requires no additional space in the tack compartment 200 as compared to conventional stationary saddle racks. Therefore, users are not required to modify the trailer to accommodate the moveable saddle rack 500. The vertically translatable moveable saddle rack 500 can be used in buildings, such as horse barns or stables. The vertically translatable moveable saddle rack 500 can also be used in standard horse trailers as well as stock combo trailers. In an implementation, the moveable saddle rack 500 is installed in a standard location within a standard horse trailer as shown in FIG. 7, with the stationary frame portion 512 coupled to a fixture 270 within the tack compartment 200 of the trailer. Even though a user can access the tack compartment 200 shown in FIG. 7 from the back of a standard horse trailer, the upper saddle seat 120 can still be difficult to reach, as it is typically positioned above a user's head. In various implementations, the moveable saddle rack 500 may be factory installed in a trailer, or the moveable saddle rack 500 may be retrofit into an existing trailer originally equipped with a conventional stationary saddle rack.

The moveable saddle racks 100, 500 as depicted and described are mechanically operable, requiring no electricity or other source of power to operate. The present disclosure also contemplates moveable saddle racks that are electrically operable, hydraulically operable, pneumatically operable, or operable by a combination of modes. An electrically operable moveable saddle rack may function under the electrical system of the trailer.

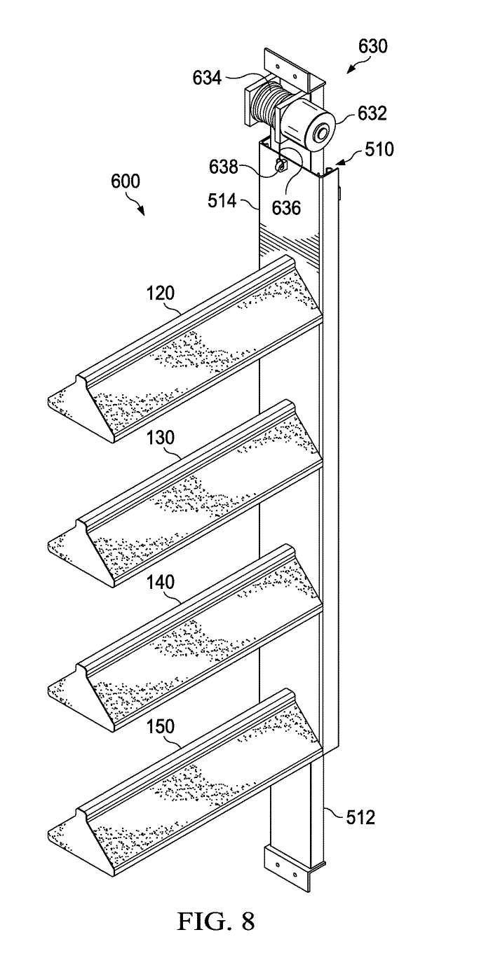

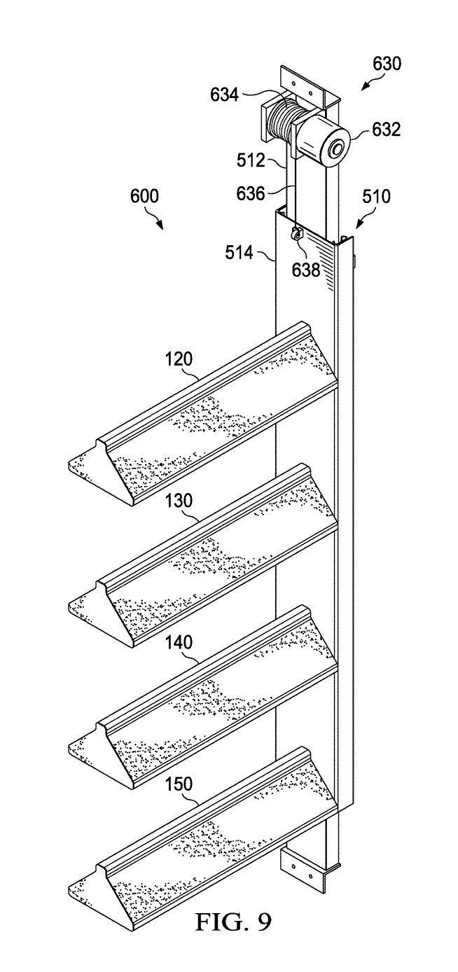

FIGS. 8 and 9 depict front side perspective views of another implementation of a vertically translatable moveable saddle rack 600 that is electrically operable. FIG. 8 depicts the moveable saddle rack 600 at a storage height and FIG. 9 depicts the moveable saddle rack 600 at a load height. When describing the moveable saddle rack 600 shown in FIGS. 8 and 9, like reference numerals correspond to like features of moveable saddle racks 100, 500.

The moveable saddle rack 600 may comprise an actuator operable to aid the vertical translation of the moveable frame portion 514 from one height to another with respect to the stationary frame portion 512. In an implementation, the actuator is an electrical actuator, such as an electric winch 630 having a drive motor 632 that rotationally drives a drum 634 around which is wrapped a wire 636 coupled to the moveable frame portion 514. In an implementation, the wire 636 couples to the moveable frame portion 514 via a hook or loop 638.

In various implementations, the electric winch 630 may be mounted to the stationary frame portion 512 as shown in FIGS. 8 and 9, or the electric winch 630 may be mounted to a structure of the tack compartment 200, such as to the ceiling 250 or to a fixture 270.

For the moveable saddle rack 600 with an electric winch 630, the retainer 520 shown in FIG. 3 is not necessary to maintain the two portions 512, 514 of the frame 510 coupled together at the storage height. Instead, the retainer 520 may optionally be eliminated because the electric winch 630 is operable to raise, lower and maintain the moveable frame portion 514 at any desired height along its range of movement with respect to the stationary frame portion 512, including maintaining the moveable frame portion 514 at the storage height as shown in FIG. 8.

Like the moveable saddle rack 500, the moveable saddle rack 600 may further comprise a vertical translation system 540 as shown in FIG. 4-6. In various implementations, the vertical translation system 540 may comprise wheels, rollers, bearings, sliders, or other mechanisms that facilitate vertical translation of the moveable frame portion 514 with respect to the stationary frame portion 512. In an implementation, the vertical translation system 540 may comprise an upper roller system 542 and a lower roller system 544. The roller systems 542, 544 may each comprise a plurality of bars 541, 543 coupled to the stationary frame portion 512 and each supporting a roller 545 disposed within a track 515 of the moveable frame portion 514. In other implementations, the roller systems 542, 544 may each comprise a single bar extending between two rollers 545 disposed within tracks 515 on either side of the moveable frame portion 514. The rollers 545 are operable to vertically translate along tracks 515 as the moveable frame portion 514 is lifted downwardly or upwardly with respect to the stationary frame portion 512.

Referring again to FIGS. 8 and 9, in operation, a user will first determine whether or not to operate the moveable saddle rack 600. In some circumstances, such as when loading and unloading saddles from the lower saddle seats 140, 150, there may be no need to vertically translate the moveable saddle rack 600. If a user decides to operate the moveable saddle rack 600 to access one or more of the upper saddle seat(s) 120, 130 for storing or retrieving saddles, the user provides power to the drive motor 632 of the electric winch 630 to rotate the drum 634 and thereby unspool the wire 636 coupled to the moveable portion 514 of the frame 510.

As the wire 636 unspools, the weight of the moveable frame portion 514 causes the vertical translation system 540 to vertically translate the moveable frame portion 514 downwardly via rollers 545 moving along the tracks 515. In this manner, the moveable saddle rack 600 is vertically translated downwardly from the storage height shown in FIG. 8 to a load height shown in FIG. 9 that facilitates user access to the upper saddle seats 120, 130. In an implementation, the moveable frame portion 514 vertically translates approximately 10-inches with respect to the stationary frame portion 512, but other distances are contemplated by the present disclosure. When the moveable saddle rack 600 reaches the load height, the user discontinues providing power to the drive motor 632 and the movement stops. Thus, the electric winch 630 controls the lowering of moveable saddle rack 600 from the storage height to the load height, or any position therebetween, based on how long the user provides power to the drive motor 632 to rotate the drum 634 and thereby unspool the wire 636.

Once the user has finished loading or unloading saddles from the moveable saddle rack 600 in the load position, the user may reverse the rotational direction of the drive motor 632 and then provide power thereto to rotationally drive the drum 634 in the opposite direction and thereby spool the wire 636 onto the drum 634. As the wire 636 is spooled onto the drum 634, the moveable frame portion 514 is pulled upwardly by the wire 636 while the vertical translation system 540 vertically translates the moveable frame portion 514 upwardly via rollers 545 moving along the tracks 515. In this manner, the moveable saddle rack 600 is vertically translated upwardly to the storage height shown in FIG. 8. When the moveable saddle rack 600 reaches the storage height, the user discontinues providing power to the drive motor 632 and the movement stops. The electric winch 630 is operable to retain the moveable saddle rack 600 at the storage height.

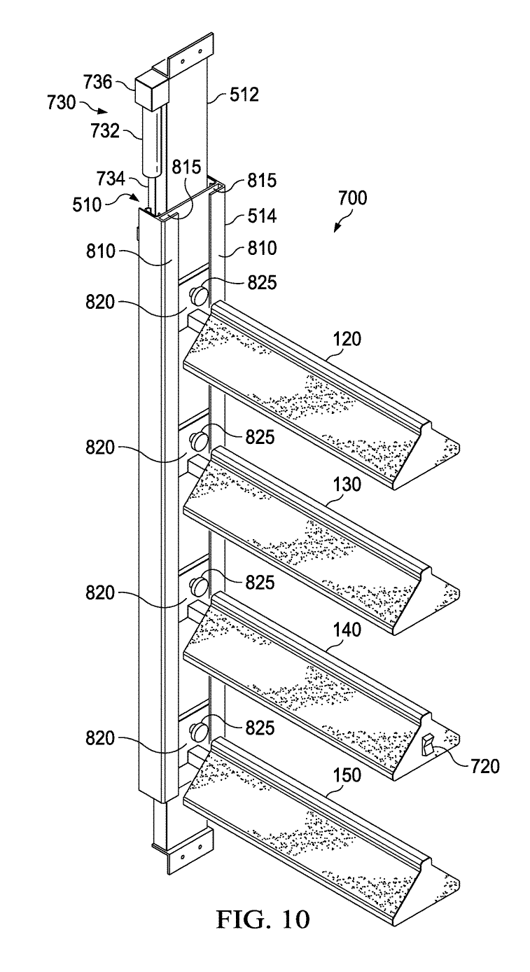

Referring now to FIGS. 10-12, which depict a front side perspective view, a back side perspective view, and a partial back plan view, respectively, of another implementation of a vertically translatable moveable saddle rack 700 that is mechanically and electrically operable. When describing the moveable saddle rack 700 shown in FIGS. 10-12, like reference numerals correspond to like features of moveable saddle racks 100, 500, 600.

The moveable saddle rack 700 may comprise an actuator operable to aid the vertical translation of the moveable frame portion 514 from one height to another with respect to the stationary frame portion 512. In an implementation, the actuator is a combination mechanical actuator and electrical actuator, such as a gas cylinder 530 and an electric actuator 730. The gas cylinder 530 includes a piston chamber 532 and a piston rod 534 that engages a bar 516 coupled to and forming part of the moveable frame portion 514. The electric actuator 730 includes a drive motor 736, a piston chamber 732 and a piston rod 734. The electric actuator 730 is inverted, with the drive motor 736 coupled to the stationary frame portion 512 and the piston rod 734 engaging the bar 516 coupled to and forming part of the moveable frame portion 514. In an implementation, the electric actuator 730 is a 12-volt actuator, but other sizes are contemplated by the present disclosure.

In various implementations, the gas cylinder 530 assists the electric actuator 730 in lifting the moveable frame portion 514 with respect to the stationary frame portion 512. The assistance provided by the gas cylinder 530 reduces the voltage requirements of the electric actuator 730, thereby reducing the associated expense, without sacrificing the operational speed. The assistance provided by the gas cylinder 530 also reduces the lifting requirements of the electric actuator 730 such that it pulls less current. In some implementations, the electric actuator 730 may be directly connected to existing 14-16 gauge trailer wiring rather than requiring larger gauge wiring or an additional battery.

For the moveable saddle rack 700 with the combination mechanical actuator and electrical actuator, the retainer 520 shown in FIG. 3 is not necessary to maintain the two portions 512, 514 of the frame 510 coupled together at the storage height. Instead, the retainer 520 may optionally be eliminated because the electric actuator 730 is operable to raise, lower and maintain the moveable frame portion 514 at any desired height along its range of movement with respect to the stationary frame portion 512. As shown in FIG. 10, for ease of access to the user, an electric actuator control switch 720 may be provided in any convenient location, including on the front of any of the saddle seats 120, 130, 140, 150, such as saddle seat 140, for operating the electric actuator 730.

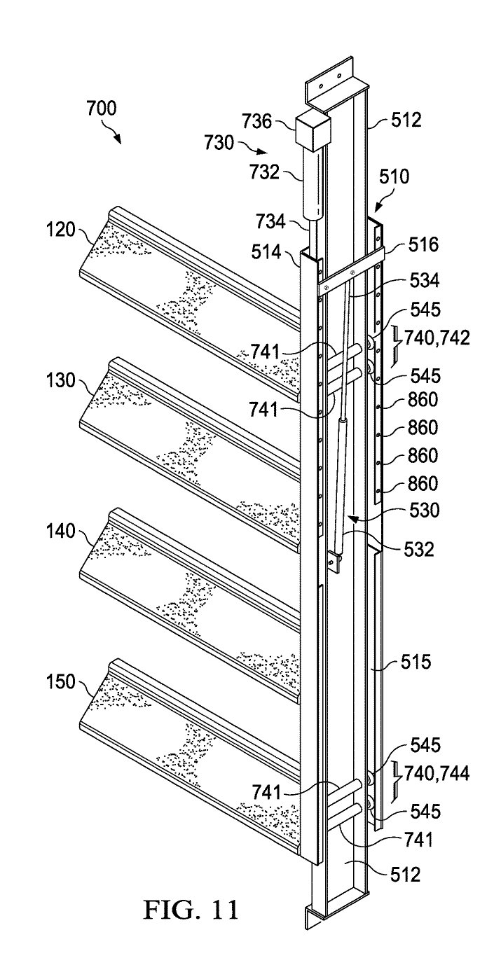

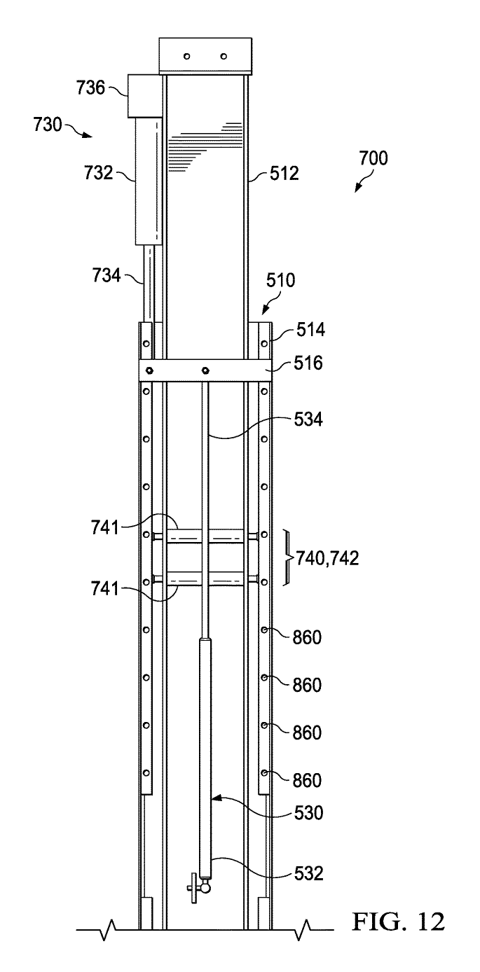

Like the moveable saddle racks 500 and 600, the moveable saddle rack 700 may further comprise a vertical translation system 740 as shown in FIGS. 11 and 12. In various implementations, the vertical translation system 740 may comprise wheels, rollers, bearings, sliders, or other mechanisms that facilitate vertical translation of the moveable frame portion 514 with respect to the stationary frame portion 512. In an implementation, the vertical translation system 740 may comprise an upper roller system 742 and a lower roller system 744. The roller systems 742, 744 may each comprise one or more bars 741, each bar 741 extending between two rollers 545 disposed within tracks 515 on either side of the moveable frame portion 514. In other implementations, the moveable saddle rack 700 may employ the vertical translation system 540 shown in FIGS. 4-6, each comprising a plurality of bars 541, 543 coupled to the stationary frame portion 512 and each bar 541, 543 supporting a roller 545 disposed within a track 515 of the moveable frame portion 514. Other configurations of vertical translation systems are contemplated by the present disclosure. The rollers 545 are operable to vertically translate along tracks 515 as the moveable frame portion 514 is moved downwardly or upwardly with respect to the stationary frame portion 512.

In operation, a user will first determine whether or not to operate the moveable saddle rack 700. In some circumstances, such as when loading and unloading saddles from the lower saddle seats 140, 150, there may be no need to vertically translate the moveable saddle rack 700. If a user decides to lower the moveable saddle rack 700 from the storage position to access one or more of the upper saddle seat(s) 120, 130 for storing or retrieving saddles, the user provides power, such as via the electric actuator control switch 720, to the drive motor 736 of the electric actuator 730. The electric actuator 730 then extends the piston rod 734 downwardly from the piston chamber 732, thereby exerting a downward force by the piston rod 734 against the plate 516 coupled to the moveable frame portion 514.

As the downward force is exerted by the electric actuator 730, the vertical translation system 740 vertically translates the moveable frame portion 514 downwardly via rollers 545 moving along the tracks 515. In this manner, the moveable saddle rack 700 is vertically translated downwardly from the storage height to a load height that facilitates user access to the upper saddle seats 120, 130. During the downward vertical translation, the weight of saddles on the saddle seats 120, 130, 140, 150 may be sufficient to overcome the upward force exerted by the gas spring 530. In some implementations, the gas spring 530 is designed such that the electric actuator 730 uses no more than half of its rated force to vertically translate the moveable frame portion 514 downwardly, even when there are no saddles on the saddle seats 120, 130, 140, 150. In an implementation, the moveable frame portion 514 vertically translates approximately 10-inches with respect to the stationary frame portion 512, but other distances are contemplated by the present disclosure. When the moveable saddle rack 700 reaches the load height, the user discontinues providing power to the drive motor 736 and the movement stops. Thus, the electric actuator 730 controls the lowering of moveable saddle rack 700 from the storage height to the load height, or any position therebetween, based on how long the user provides power to the drive motor 736 to thereby extend the piston rod 734.

Once the user has finished loading or unloading saddles from the moveable saddle rack 700 in the load position, the user may reverse the direction of the drive motor 736 and then provide power thereto, such as via electric actuator control switch 720, to withdraw the piston rod 734 into the piston chamber 732. As the piston rod 734 is withdrawn into the piston chamber 732, the moveable frame portion 514 is pulled upwardly by the piston rod 734 (coupled to plate 516) while the vertical translation system 740 vertically translates the moveable frame portion 514 upwardly via rollers 545 moving along the tracks 515. During the upward vertical translation, the gas spring 530 aids the electric actuator 730 so that not as much force is required to lift the weight of the moveable frame portion 514. In this manner, the moveable saddle rack 700 is vertically translated upwardly to the storage height. When the moveable saddle rack 700 reaches the storage height, the user discontinues providing power to the drive motor 736 and the movement stops. The electric actuator 730 and gas spring 530 are operable to retain the moveable saddle rack 700 at the storage height.

In an implementation, the laterally translatable saddle rack 100 and any of the vertically translatable saddle racks 500, 600, 700 disclosed herein may be combined to form a moveable saddle rack that is both laterally translatable and vertically translatable. In the combined implementation, once the moveable saddle rack is laterally translated from the travel position shown in FIG. 1 to the access position shown in FIG. 2, the moveable saddle rack may be vertically translated downwardly from the storage height to the load height to facilitate user access to all of the saddle seats 120, 130, 140, 150 for loading and unloading saddles.

The moveable saddle racks 100, 500, 600, 700 of the present disclosure allow for loading and unloading saddles without users having to step up into or down from the tack compartment 200 of a trailer carrying those saddles. This increases the speed and efficiency of loading and unloading saddles, and lowers the required physical exertion. The moveable saddle racks 100, 500, 600, 700 of the present disclosure also lower the risk of physical injury to backs, ankles, knees and hands during operation.

In various implementations, the moveable saddle racks 100, 500, 600, 700 depicted and described herein may be modified to include adjustability in the various components. For example, any of the moveable saddle racks 100, 500, 600, 700 may include adjustable saddle seats 120, 130, 140, 150. Referring now to FIG. 10, in an implementation, the frame of the saddle rack may include longitudinal channels 810 with grooves 815 operable to receive an adjustable bracket 820 coupled to each saddle seat 120, 130, 140, 150. The adjustable bracket 820 is slidingly received within the grooves 815 to allow for longitudinal positioning of each saddle seat 120, 130, 140, 150, and the spacing therebetween, at any increment along the length of the frame. Each adjustable bracket 820 includes a set knob 825 that may be tightened by hand to maintain the saddle seat 120, 130, 140, 150 in a desired longitudinal position.

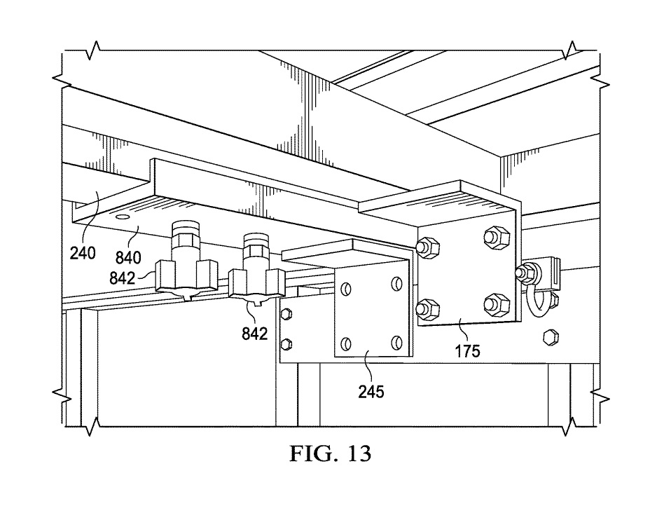

Referring now to FIG. 13, in some implementations, the laterally translatable moveable saddle rack 100 may include an adjustable rear latch receiver 245 coupled to an extruded component 840 operable to slide over the track 240 for adjustable positioning. Once the rear latch receiver 245 is positioned, the extruded component 840 may be set into place with respect to the track 240 by one or more set knobs 842 that may be tightened by hand. In this manner, the rear latch receiver 245 may be adjustably coupled to the track 240 to allow variations in the position of the rear latch receiver 245, as needed, to properly engage the rear latch 175.

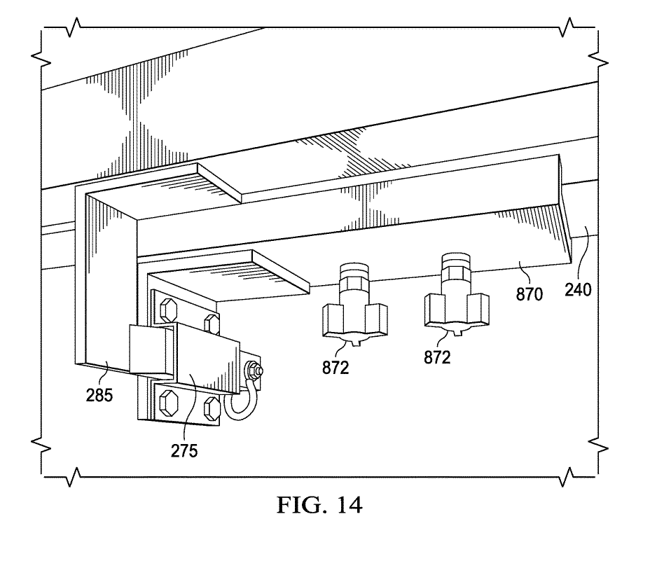

Likewise, referring now to FIG. 14, the laterally translatable moveable saddle rack 100 may include an adjustable front latch 275 coupled to an extruded component 870 operable to slide over the track 240 for adjustable positioning. Once the adjustable front latch 275 is positioned, the extruded component 870 may be set into place with respect to the track 240 by one or more set knobs 872 that may be tightened by hand. In this manner, the front latch 275 may be adjustably coupled to the track 240 to allow variations in the position of the front latch 275, as needed, to properly engage the front latch receiver 285.

Referring now to FIGS. 11 and 12, the vertically translatable moveable saddle racks 500, 600, 700 may include adjustment holes 860 drilled into the moveable frame portion 514 to allow for variations in the storage height of the moveable saddle racks 500, 600, 700. The adjustment holes 860 provide additional bolt holes for positioning the height of the plate 516 for coupling to the moveable frame portion 514. The height of the plate 516 sets the vertical translation range, which may range from 12-inches to 16-inches in some implementations.

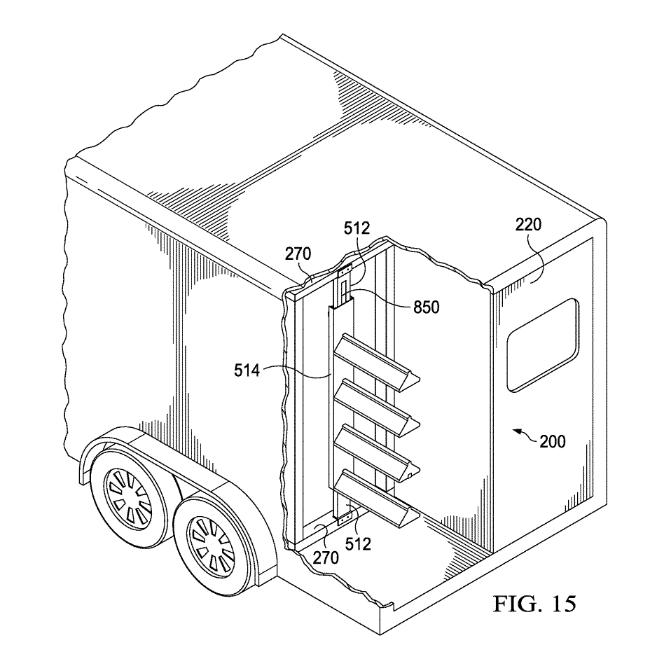

Referring now to FIG. 15, the vertically translatable moveable saddle racks 500, 600, 700 may include an extended slotted channel 850 at the top of the stationary frame portion 512 to allow for adjustability in positioning of the overall frame 510 as needed to set the height based on distance between the upper and lower fixtures 270 within a tack compartment 200 of a standard horse trailer.

In addition to the specific moveable saddle racks 100, 500, 600, 700 that have been depicted and described, various other types of moveable saddle racks are contemplated that may be designed to laterally translate from one position to another and/or vertically translate from one height to another.

It is to be understood the implementations are not limited to particular systems or processes described which may, of course, vary. It is also to be understood that the terminology used herein is for the purpose of describing particular implementations only, and is not intended to be limiting. As used in this specification, the singular forms “a”, “an” and “the” include plural referents unless the content clearly indicates otherwise. As another example, “coupling” includes direct and/or indirect coupling of members.

Although the present disclosure has been described in detail, it should be understood that various changes, substitutions and alterations may be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. An apparatus comprising:
a moveable saddle rack comprising a frame supporting a plurality of saddle seats spaced apart in a stacked vertical arrangement;
wherein the moveable saddle rack is laterally translatable from a first location to a second location.

2. The apparatus of claim 1, further comprising:
a translation assembly coupled to the frame;
wherein the translation assembly is adapted to travel along a track disposed on an interior surface of a building or a trailer.

3. The apparatus of claim 2, further comprising:
a latch receiver on one of the translation assembly and the track; and
a latch on the other of the translation assembly and the track;
wherein the latch is adapted to engage the latch receiver to maintain the moveable saddle rack in the first location or the second location.

4. The apparatus of claim 3, further comprising:
a release mechanism operable to withdraw the latch from the latch receiver to facilitate lateral translation of the moveable saddle rack.

5. The apparatus of claim 1:
wherein the spacing of the plurality of saddle seats on the frame is adjustable.

6. The apparatus of claim 3:
wherein the position of at least one of the latch receiver and the latch is adjustable.

7. The apparatus of claim 1:
wherein a moveable portion of the frame is vertically translatable from a first height to a second height with respect to a stationary portion of the frame.

8. The apparatus of claim 7:
further comprising an actuator that facilitates vertical translation of the moveable frame portion.

9. The apparatus of claim 8:
wherein the actuator comprises a mechanical gas spring.

10. The apparatus of claim 8:
wherein the actuator comprises an electric winch.

11. The apparatus of claim 8:
wherein the actuator comprises an electric piston actuator.

12. The apparatus of claim 8:
wherein the actuator comprises a mechanical gas spring and an electric piston actuator.

13. The apparatus of claim 7:
wherein the distance between the first height and the second height is adjustable.

14. The apparatus of claim 7:
wherein the height of the stationary frame portion is adjustable.

15. A method of accessing a saddle rack, the method comprising:
laterally translating a saddle rack from a travel position proximate to a wall of a trailer to an access position proximate to an entry door of the trailer; and
loading or unloading a saddle from the saddle rack without stepping into the trailer.

16. The method of claim 15, the method further comprising:
laterally translating the saddle rack back to the travel position after loading or unloading the saddle.

17. The method of claim 15, the method further comprising:
vertically translating at least one portion of the saddle rack downwardly from a storage height to a load height before loading or unloading the saddle from the saddle rack.

18. The method of claim 17, the method further comprising:
vertically translating the at least one portion of the saddle rack back to the storage height after loading or unloading the saddle.

19. The method of claim 17, wherein the vertical translating is achieved mechanically.

20. The method of claim 17, wherein the vertical translating is achieved electrically.

21. The method of claim 17, wherein the vertical translating is achieved electrically and mechanically.
